(19) United States
(12) Patent Application Publication
(10) Pub. No.: US 2014/0102545 A1
(43) Pub. Date: Apr. 17, 2014

(54) Spa/Pool Device Interface

(71) Applicant: LMI ROTO, LLC, Lake Mary, FL (US)

(72) Inventor: Gary Harder, Lake Mary, FL (US)

(73) Assignee: LMI ROTO, LLC, LAKE MARY, FL (US)

(21) Appl. No.: 13/650,666

(22) Filed: Oct. 12, 2012

(51) Int. Cl. F16L 55/00; B21D 51/16

(52) U.S. Cl. 137/15.01; 285/80

(57) ABSTRACT

A system for removably connecting plumbing to a device includes a flange, one end of which is configured to bond to the plumbing. An insertion area at a distal end of the flange is sized and shaped to fit within a port of the device. An o-ring seat is cut/formed across a perimeter (e.g. outer circumference) of the insertion area of the flange. An o-ring is positioned around/in the o-ring seat such that, after insertion of the insertion area of the flange into the port, the o-ring provides a seal between the insertion area and an inner surface of the port. A retention device such as a retention nut holds the insertion area within the port.

This application is also related to U.S. patent application Ser. No. titled Spa Jet Interface, attorney docket number 2699.10, filed evendate herewithin.

### FIELD

This invention relates to the field of spa/hot-tub plumbing and more particularly to a system and method for interfacing plumbing to a device such as a pump.

### BACKGROUND

Spas, hot tubs and pools have pumps for circulating water from the spa/hot-tub/pool through a filter, and back out through various orifices or jets. For many Spas, hot tubs and pools, the water is circulated through a series of pipes, typically polyvinylchloride tubing (PVC). It is well known how to plumb with such tubing, using couplings, PCV cleaner, and PVC cement to join such tubing. Good PVC joints are relatively easy to make, very cost effective, have very low chances of leakage, and are structurally sound. Proper PCV joints are often so good that it is physically impossible to separate the joined PCV sections without damaging the PVC tubing and/or coupling (as opposed to, for example, copper sweat fittings that are easily separated by heating the fitting).

Unfortunately, there are components in the circulation system that may, at times, require replacement. Examples of such components are pumps and heaters. If the above mentioned method of coupling is used to join a PVC tube/pipe directly to a Spa, hot tub, or pool device (e.g. pump or heater), it would be extremely difficult to later break this coupling when the pump needs replacement (e.g. when the pump seal fails as often is the case). Instead, the PCV tube/pipe is coupled to a flange that has a threaded retaining nut. The retaining nut is placed onto the PVC tube/pipe, and then the PCV tube/pipe is coupled to the flange (e.g. using the cleaner/adhesive method). After the adhesive sets, a washer or o-ring is placed between the flange and the pump inlet/outlet and the retaining nut is threaded onto the pump inlet/outlet, applying pressure between the pump inlet/outlet and the flange, thereby removably sealing the flange and PVC pipe/tube to the pump inlet/outlet.

This method of connecting the spa, hot tub, and pool plumbing to repairable/replaceable devices (e.g. pumps or heaters) has been used to some extent for many years. The method requires substantial torque on the retaining nut in order to apply proper pressure on the washer or o-ring to prevent leaks. It is often difficult to apply the needed torque due to the location and/or orientation of the device (e.g. pump or heater) within cabinetry, etc. Over torqueing is also a problem, resulting in stripping of the threads on either the device (e.g. pump or heater) or the retaining nut or both. Over torqueing also leads to difficulties in removing the retaining nut and potential breakage/stripping of the retaining nut during removal. Under and over tightening also lead to leakage problems that sometimes occur months or years after installation. Although an under tightened retaining nut is often easy to tighten, when deployed within a home, the leak often goes unnoticed until serious structural issues or mold occurs. Additionally, placement of the washer/o-ring is a problem, in that, a skewed washer/o-ring will result in one area that is properly sealed and another area that has insufficient pressure to result in a proper seal, again leading to eventual leaking. Once the retaining nut is in place, there is no way to see how the washer/o-ring is situated.

The sealing systems of the prior art rely upon the torque of the retaining nut to maintain a proper seal. Many applications include periodic heat/cool cycles such as weather related or when a pool/spa heater cycles on and off. Such heat/cool cycles often lead to reduction of torque and/or reduction of proper pressure on the washer/o-ring.

What is needed is a coupling system that will couple a removable device to fixed plumbing with little or no leaking.

### SUMMARY

In one embodiment, a system for removably connecting plumbing to a device is disclosed. The device has a port. The system includes a flange, one end of which is configured to bond to the plumbing. An insertion area at a distal end of the flange is sized and shaped to fit within the port of the device. An o-ring seat is cut or formed across a perimeter (e.g. outer circumference) of the insertion area of the flange. An o-ring is placed around the o-ring seat such that, after insertion of the insertion area of the flange into the port, the o-ring provides a seal between the insertion area and an inner surface of the port. A retention device such as a retention nut holds the insertion area within the port.

In another embodiment, a system for removably connecting plumbing to a pool/spa pump is disclosed. The pool/spa pump has an inlet port. The system includes a flange, one end of which is configured to bond to the plumbing. An insertion area at a distal end of the flange is sized and shaped to fit within the inlet port of the pool/spa pump. An o-ring seat is cut or formed across a perimeter of the insertion area of the flange and an o-ring is positioned within the o-ring seat such that, after insertion of the insertion area of the flange into the inlet port, the o-ring provides a seal between the insertion area and an inner surface of the inlet port. A retention device such as a retention nut holds the insertion area within the port.

In another embodiment, a method of removably attaching and sealing PCV plumbing to a pool/spa pump is disclosed. The pool/spa pump has a port. The method includes placing the retaining nut as above over the plumbing then applying PCV cleaning fluid to an inside surface of the one end of the flange and to an outside surface of an end of the PVC plumbing. Next, PCV adhesive to both the inside surface of the one end of the flange and the outside surface of the end of the PCV plumbing and the end of the PVC plumbing is inserted into the one end of the flange and the adhesive is allowed to set. The o-ring is installed onto the o-ring seat of the flange and the insertion area of the flange is pushed into the port, thereby sealing between the flange and the inside area of the port. The retaining nut is tightened around an outside threaded area of the port, thereby holding the insertion area within the port.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of an exemplary pump coupling system of the prior art.

FIG. 2 illustrates a second perspective view of an exemplary pump coupling system of the prior art.

FIG. 3 illustrates a perspective view of a pump coupling having an improved sealing system.

FIG. 4 illustrates a cross sectional view of a pump coupling having an improved sealing system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In the following description, examples of coupling plumbing to a pump are used to best illustrate the method of coupling plumbing to a removable and/or replaceable device. Even though the described system is very effective for interfacing plumbing (e.g. PCV pipes) to a pump, as shown, there are no limitations as to the target system (e.g. a spa system, hot-tub system, pool system, etc.) and there are no limitations as to the device being connected (e.g. solenoid valves, pumps, heating elements, heating units, etc.). There are many applications of the disclosed system for coupling and the examples used are just that, examples.

In the following description, examples of coupling plumbing to a pump to PVC plumbing are used to best illustrate the method of coupling to such plumbing. PCV plumbing is widely used for spa, hot-tub, and pool systems, but the present invention is not limited to spa, hot-tub, and pool systems as any plumbing system is anticipated. Likewise, although PVC plumbing is used to best illustrate the method of coupling, any type and/or composition of tubing/pipe is anticipated including, but not limited to, plastic tubing, metal tubing, copper tubing, electrical conduit, hose, rubber hose, etc.

The examples of the system, method, and apparatus for coupling plumbing to a device in this description use a tubular inlet/outlet on the device mating with a tubular flange. Although a tubular inlet/outlet is typical mating with flange having a circular cross section, there is no shape/geometric limitation. For example, in some embodiments, the inlet/outlet has an oval cross-section and the flange conforms to the oval shape of the portion of the inlet/outlet in which it interfaces. Any geometric cross-sectional shape is anticipated, and specialized o-rings are also anticipated for use with cross-sectional shapes that have sharp edges (e.g. a triangular or square cross-sectional shape will work better using a triangular or square shaped o-ring).

The disclosed sealing system takes advantage of the substantially smooth (e.g. regular) inner surface of device connections. A flange fits within the device connection and has one or more o-rings (e.g., a gasket in the shape of a torus made of an elastomer) interfaced between the flange and the device connection, thereby sealing from leaks, particularly, though not limited, from leaks of a liquid/gas. The o-rings enable a good seal without the requirement of torqueing a retaining nut to provide this seal. Although o-rings are typically circular in cross-section, for some applications, any closed-loop elastomer is anticipated with cross-sectional shapes that match the device connection and flange, including, but not limited to, oval, triangular, square, hexagonal, octagonal and irregular shapes.

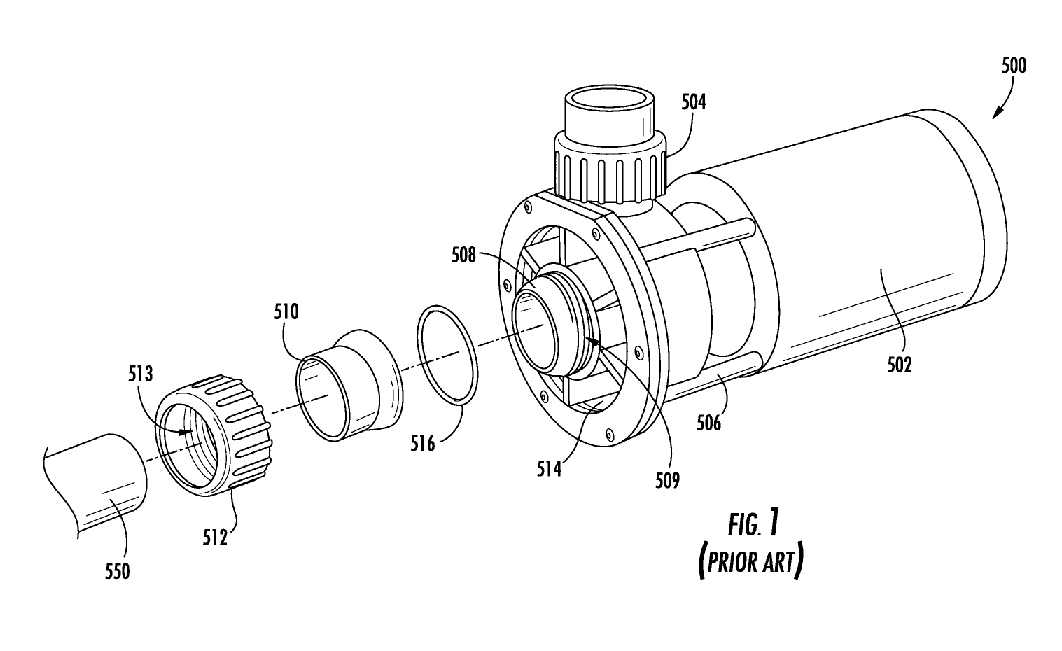

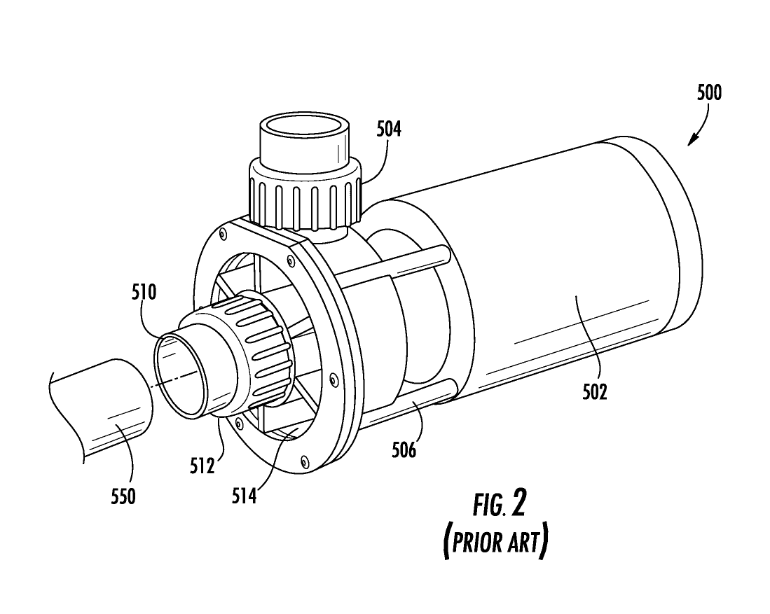

Referring to FIGS. 1 and 2, perspective views of an exemplary pump coupling system of the prior art are shown. A typical pump 514 is shown with mounting standoffs 506, connecting the pump 514 to a motor 502. A shaft of the motor 502 typically interfaces with an impeller (not visible) within the pump 514. Although shown as a typical impeller-type pump 514, the disclosed system is anticipated for use with any existing pump.

In operation, a liquid (e.g. water) is sucked in through an inlet 508 of the pump 514 and is discharged through an outlet 504 of the pump 514. The inlet 508 and outlet 504 are coupled to plumbing (not shown) to connect the pump 514 to the spa, hot-tub, or pool water through various orifices, for example, jets, drains, filter arrangements, weirs, etc.

In the prior art, the pump is connected to plumbing (one section of plumbing 550 is shown) through a flange 510. In typical pools, spas and hot-tubs, the plumbing 550 is a section of PVC pipe/tube and the end of the PCV pipe/tube 550 is bonded to the flange 510 using PCV pipe cleaner and PVC pipe adhesive (not shown) to provide a substantially permanent bond between the flange 510 and the plumbing 550. Note that the retaining nut 512 needs to be over the plumbing 550 before the plumbing 550 is bonded to the flanged 510 or there needs to be access to slide the flange 510 over the plumbing 550 after the plumbing 550 is bonded to the flange 510.

After the plumbing 550 is bonded to the flanged 510, a washer or o-ring 516 is situated between the flange 510 and the pump inlet 508 and the retaining nut 512 is threaded onto threads 509 of the inlet 508 (the retaining nut 512 has mating threads 513) and tightened to seat the washer/o-ring 516 between the flange 510 and the pump inlet 508. In order to prevent leaks, the washer/o-ring 516 must be properly positioned and the retaining nut 512 must be torqued sufficiently to apply appropriate pressure to the washer/o-ring 516. In the prior art, it is often difficult to properly position washer/o-ring 516 and to apply proper torque to the retaining nut 512 due to interfering structures, plumbing, electronics, etc. Furthermore, many pools, spas, and hot-tubs are heated. Such heating and/or weather cycles result in heating and cooling cycles of the connection between the pump inlet 508 and the flange 510, thereby affecting the performance of the washer/o-ring 516, leading to leaks.

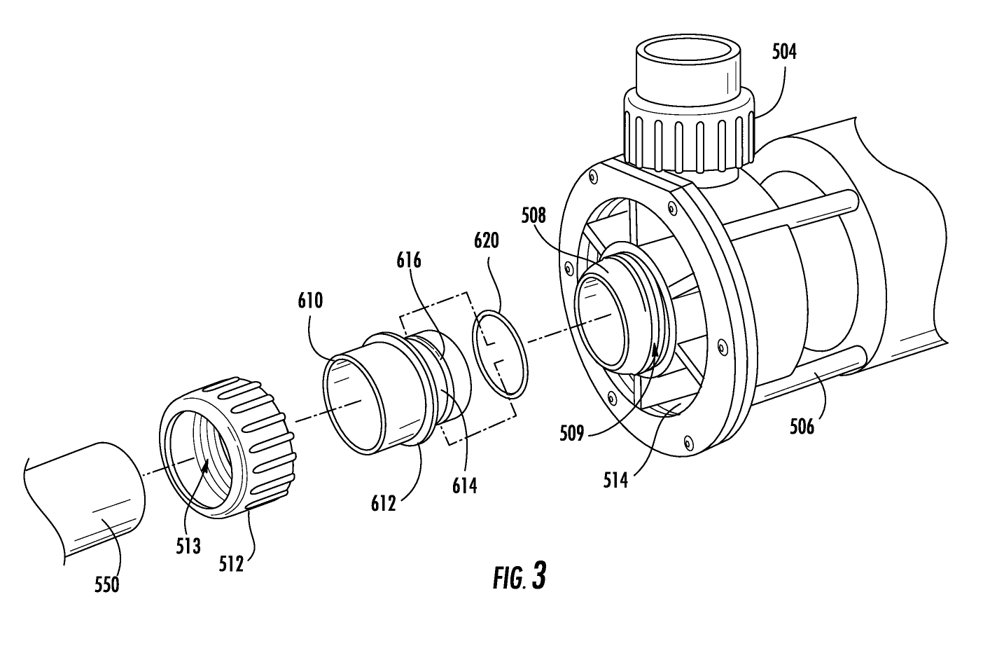

Referring to FIG. 3, a perspective view of a pump coupling having an improved sealing system is shown. As in the description of the prior art, a typical pump 514 is shown with mounting standoffs 506, connecting the pump 514 to a motor 502. A shaft of the motor 502 typically interfaces with an impeller (not visible) within the pump 514. Although shown as a typical impeller-type pump 514, the disclosed system is anticipated for use with any type of pump.

In operation, a liquid (e.g. water) is sucked in through an inlet 508 (suction side) of the pump 514 and is discharged through an outlet 504 (discharge side) of the pump 514. The inlet 508 and outlet 504 are coupled to plumbing (only one section of plumbing 550 is shown for clarity reasons) to connect the pump 514 to the spa, hot-tub, or pool water through various orifices, for example, jets, drains, filter arrangements, weirs, etc. Again, note that a spa, hot-tub, pool situation is used as an example for connecting plumbing 550 to a device such as a pump 514 and any other plumbing/system such as PCV pipe/tubes, plastic pipes/tubes, copper pipes/tubes, electrical conduit, etc.; and/or devices such as heaters, heating elements, solenoid valves, filter units, etc., are anticipated.

The inlet 508 of the pump 514 is connected to plumbing (one section of plumbing 550 is shown) through a flange 610. Likewise, it is anticipated that the outlet 504 be connected in a similar way. In typical pools, spas and hot-tubs, the plumbing 550 is a section of PVC pipe/tube and the end of the PCV pipe/tube 550 is bonded to the flange 610 using PCV pipe cleaner and PVC pipe adhesive (not shown) to provide a substantially permanent bond between the flange 610 and the plumbing 550. This substantially permanent bond is extremely difficult to break, often requiring destruction of either the flange 610 and/or the plumbing 550 and often requires sawing the flange 610 off of the plumbing 550.

Note that the retaining nut 512 needs to be placed over the plumbing 550 before the plumbing 550 is bonded to the flanged 610 or there needs to be access to slide the flange 610 over the plumbing 550 after the plumbing 550 is bonded to the flange 610.

O-rings 620 form very good seals and are used in many water sealing systems in device such as faucets and drains. As discussed above, in the past, a washer or o-ring 516 was placed between a flange 510 and the device 514 and pressure was applied between the flange 510 and the device 514 by a retaining nut 512. As discussed above, such seals have known issues.

The interface/seal shown has a superior seal and requires no pressure between the flange 610 and the device 514 to retain this seal because the o-ring(s) 620 seal between o-ring grooves 616 and an inner wall of the, for example, inlet port 508 (or the outlet port 504). Although not required, it is preferred that there is a retainment mechanism (e.g. a snap, wedge, press-fit, screw, snap, etc.) that retains the flange 610 within the, for example, inlet 508, in this example, the original retaining nut 512 is used to keep an interface area 614 of the flange 610 within the inlet 508. The interface area 614 of the flange 610 has an outer cross-sectional shape that is substantially the same as an inner cross-sectional shape of the inlet 508 (circular cross-sectional shape in this example) and the interface area 614 has a cross-sectional outer dimensions that is substantially the same as a cross-sectional inner dimension of the inlet 508, thereby the interface area 614 of the flange 610 fits into the inlet 508. This fit ranges from a relatively tight fit, perhaps requiring some amount of force to insert the interface area 614 into the inlet 508 or a loose fit which requires very little force to insert the interface area 614 into the inlet 508 until at least one o-ring or closed-loop elastomer seal 620 is installed in the at least one o-ring seat 616 (or closed-loop elastomer seal seat 616). A snug fit is preferred so that the o-ring or closed-loop elastomer seal 620 properly seals. In this way, no modifications need be made to existing devices 514 to interface using the disclosed improved sealing system.

Although the device 514 is shown as a typical spa, hot-tub, or pool pump 516, any device is anticipated, including, but not limited to, pumps, heating elements, heaters, filter systems, solenoid valves, etc.

Although most anticipated devices 516 have tubular connections such as the inlet 508, the disclosed system is anticipated for use with any shaped connection. In this example, the inlet 508 has a substantially tubular inner cross-section area. The outer shape and dimension of the insertion area 614 of the flange 610 is substantially similar to this inner cross-sectional area and is therefore substantially tubular as well. The inner diameter of the insertion area 614 is close to, but preferably less than, the inner diameter of the inlet 508, allowing free insertion of the insertion area 614 into the inlet 508 (before addition of o-ring(s) 620). The insertion area 614 as shown in this example has a ledge 612 that, as the insertion area 614 is inserted into the inlet 508, the ledge 612 abuts a lip of the inlet 508 and prevents over insertion, keeping an end of the insertion area 614 from extending too far into the inlet 508.

After the o-ring(s) 620 are seated into the at least one o-ring seats 616, the insertion area 614 is pushed into the pump inlet 508, compressing the o-ring(s) 620 between the o-ring seats 616 and the inner wall of the pump inlet 508. The o-ring seat(s) 616 hold the o-ring(s) 620 in place while the insertion area 614 is pushed into the pump inlet 508 so the o-ring(s) 620 don't get pushed off of the insertion area 616.

In this example, one o-ring 620 and one o-ring groove 616 are shown, though on other embodiments, any number of o-rings 620 and o-ring grooves are anticipated. The o-ring(s) 620 is/are placed into respective o-ring groove(s) 616 and the insertion area 614 is pushed into the device connection (e.g. pump inlet 508 in this example).

In this example, the retaining nut 512 is threaded onto threads 509 of the inlet 508 (the retaining nut 512 has mating threads 513) and tightened to hold the flange insertion area 614 within the pump inlet 508. As opposed to the prior art, the retaining nut 512 does not need to be tightened or torqued to apply pressure to the seal. Therefore, the retaining nut 512 need only be tightened sufficiently as to prevent the retaining nut from coming loose due to, for example, vibration, etc. Although shown as a threaded retaining nut 512, any retaining mechanism is anticipated to hold the flange insertion area 614 within the pump inlet 508 since there is no requirement for a certain amount of torque In embodiments in which the plumbing 550 has sufficient resiliency, it is anticipated that the plumbing 550 holds the flange insertion area 614 within the pump inlet 508.

Again, the described seal is anticipated for use in many situations and is not limited to any particular plumbing 550 or any particular device 516.

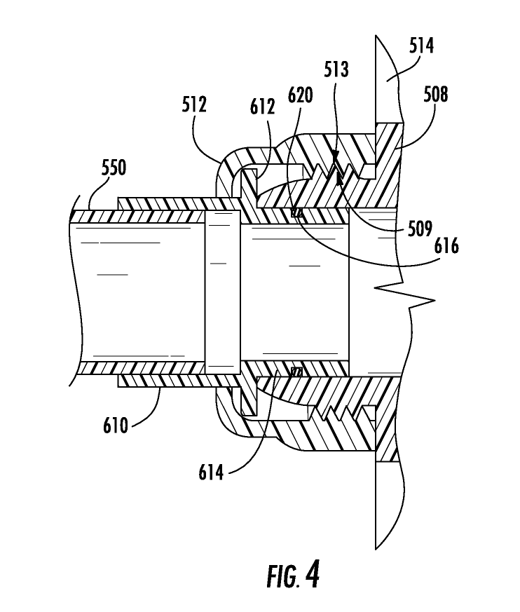

Referring to FIG. 4, a cross sectional view of a pump coupling having an improved sealing system is shown connected to an inlet 508 of a pump 516. A portion of a cross section of an inlet 509 and a portion of a typical pump 514 is shown for clarity reasons. Again, the disclosed system is anticipated for use with any device such as a pump 516, etc.

In operation, a liquid (e.g. water) is sucked in through an inlet 508 of the pump 514. The inlet 508 is coupled to plumbing (only one section of plumbing 550 is shown for clarity reasons) to connect the pump 514 to the spa, hot-tub, or pool water through various orifices, for example, jets, drains, filter arrangements, weirs, etc. Again, note that a spa, hot-tub, pool situation is used as an example for connecting any plumbing 550 to any device such as a pump 514 and any other plumbing/system such as PCV pipe/tubes, plastic pipes/tubes, copper pipes/tubes, electrical conduit, etc; and/or devices such as heaters, heating elements, solenoid valves, filter units, etc., are anticipated.

The inlet 508 is connected to plumbing (one section of plumbing 550 is shown) through a flange 610. In typical pools, spas and hot-tubs, the plumbing 550 is a section of PVC pipe/tube and the end of the PCV pipe/tube 550 is bonded to the flange 610 using PCV pipe cleaner and PVC pipe adhesive (not shown) to provide a substantially permanent bond between the flange 610 and the plumbing 550. This substantially permanent bond is extremely difficult to break, often requiring destruction of either the flange 610 and/or the plumbing 550 and often requires sawing the flange 610 off of the plumbing 550.

In this example, only one o-ring 620 and o-ring seat 616 is shown, though in other embodiments, multiple o-rings 620 and o-ring seats 616 are employed. The o-ring(s) 620 seal between o-ring grooves 616 and an inner wall of the, for example, inlet 508. Although not required, it is preferred that there is a retainment mechanism (e.g. a snap, wedge, press-fit, screw, snap, etc.) that retains the flange 610 within the, for example, inlet 508, in this example, the original retaining nut 512 is used to keep an interface area 614 of the flange 610 within the inlet 508. The interface area 614 of the flange 610 has an outer cross-sectional shape that is substantially the same as an inner cross-sectional shape of the inlet 508 (circular cross-sectional shape in this example) and the interface area 614 has a cross-sectional outer dimensions that is substantially the same as a cross-sectional inner dimension of the inlet 508, thereby the interface area 614 of the flange 610 fits into the inlet 508. This fit ranges from a relatively tight fit, perhaps requiring some amount of force to insert the interface area 614 into the inlet 508 or a loose fit which requires very little force to insert the interface area 614 into the inlet 508 until the o-ring or closed-loop elastomer seal 620 is installed in the o-ring seat 616 (or closed-loop elastomer seal seat 616). A snug fit is preferred so that the o-ring or closed-loop elastomer seal 620 properly seals. This sealing system does not require modifications need be made to existing devices 514 to interface using the disclosed improved sealing system.

After the o-ring(s) 620 are seated into the at least one o-ring seats 616, the insertion area 614 is pushed into the pump inlet 508, compressing the o-ring(s) 620 between the o-ring seats 616 and the inner wall of the pump inlet 508. The o-ring seat(s) 616 hold the o-ring(s) 620 in place while the insertion area 614 is pushed into the pump inlet 508 so the o-ring(s) 620 don't get pushed off of the insertion area 616.

In this example, the retaining nut 512 is threaded onto threads 509 of the inlet 508 (the retaining nut 512 has mating threads 513) and tightened to hold the flange insertion area 614 within the pump inlet 508. As opposed to the prior art, the retaining nut 512 does not need to be tightened or torqued to apply pressure to the seal. Therefore, the retaining nut 512 need only be tightened sufficiently as to prevent the retaining nut from coming loose due to vibration, etc. Although shown as a threaded retaining nut 512, any retaining mechanism is anticipated to hold the flange insertion area 614 within the pump inlet 508 since there is no requirement for a certain amount of torque. In embodiments in which the plumbing 550 has sufficient resiliency, it is anticipated that the plumbing 550 holds the flange insertion area 614 within the pump inlet 508.

Again, the described seal is anticipated for use in many situations and is not limited to any particular plumbing 550 or any particular device 516.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for removably connecting plumbing to a device, the device having a port, the system comprising:
a flange, one end of the flange configured to bond to the plumbing, an insertion area at a distal end of the flange sized and shaped to fit within the port of the device, an o-ring seat is cut/formed across a perimeter of the insertion area of the flange;
an o-ring, the o-ring placed within the o-ring seat such that, after insertion of the insertion area of the flange into the port, the o-ring provides a seal between the insertion area and an inner surface of the port;
a means for retaining the insertion area within the port.

2. The system of claim 1, wherein the insertion area at the distal end of the flange is sized and shaped to fit loosely within the port, allowing insertion of the insertion area into the port.

3. The system of claim 1, wherein the means for retaining the insertion area within the port is a retaining nut that threads onto threads on an outside surface of the port.

4. The system of claim 3, wherein the device is a spa/pool pump.

5. The system of claim 4, wherein the port is an inlet of the spa/pool pump.

6. The system of claim 1, wherein the plumbing is PVC pipe and the one end of the flange is bonded to the PCV pipe using PCV cleaner and PVC cement.

7. The system of claim 1, further comprising a ledge that limits how far the insertion area is inserted into the port.

8. The system of claim 1, wherein the device is selected from the group consisting of a pump, a heating element, a heating system, and a solenoid valve.

9. A system for removably connecting plumbing to a device, the device being a pool/spa pump having at least one fluid port, the system comprising:
a flange, one end of the flange configured to bond to the plumbing, an insertion area at a distal end of the flange sized and shaped to fit within one of the at least one fluid ports of the pool/spa pump, an o-ring seat is cut/formed across a perimeter of the insertion area of the flange;
an o-ring, the o-ring placed within the o-ring seat such that, after insertion of the insertion area of the flange into the one of the at least one fluid ports, the o-ring provides a seal between the insertion area and an inner surface of the one of the at least one fluid ports;
a means for retaining the insertion area within the one of the at least one fluid ports.

10. The system of claim 9, wherein the insertion area at the distal end of the flange is sized and shaped to fit loosely within the one of the at least one fluid ports, allowing insertion of the insertion area into the one of the at least one fluid ports.

11. The system of claim 9, wherein the means for retaining the insertion area within the one of the at least one fluid ports is a retaining nut that threads onto threads on an outside surface of the one of the at least one fluid ports.

12. The system of claim 9, wherein the plumbing is PVC pipe and the one end of the flange is bonded to the PCV pipe using PCV cleaner and PVC cement.

13. The system of claim 9, further comprising a ledge that limits how far the insertion area is inserted into the one of the at least one fluid ports.

14. A method of removably attaching and sealing PCV plumbing to a pool/spa pump, the pool/spa pump having a port, the method comprising:
placing the retaining nut of claim 4 over the plumbing;
applying PCV cleaning fluid to an inside surface of the one end of the flange of claim 4;
applying PCV cleaning fluid to an outside surface of an end of the PVC plumbing;
applying PCV adhesive to both the inside surface of the one end of the flange of claim 4 and the outside surface of the end of the PCV plumbing;
inserting the end of the PVC plumbing into the one end of the flange;
allowing the PVC adhesive to set;
installing the o-ring of claim 4 onto the o-ring seat of the flange of claim 4;
pushing the insertion area of the flange into the port;
tightening the retaining nut around an outside threaded area of the port, thereby holding the insertion area within the port.

15. The method of claim 14, wherein the port is an inlet port.

16. The method of claim 14, wherein the insertion end further comprises a second o-ring groove and the step of installing the o-ring includes installing a second o-ring onto the second o-ring groove.

17. The method of claim 14, wherein the cross-sectional shape of the insertion area is substantially circular and the cross-sectional shape of the inside area of the port is substantially circular.
